(19) United States
(12) Patent Application Publication
(10) Pub. No.: US 2025/0086788 A1
(43) Pub. Date: Mar. 13, 2025

(54) QUANTITATIVE MAGNETIC RESONANCE IMAGE

(71) Applicants: Technion Research & Development Foundation Limited, Haifa (IL); MEDICAL RESEARCH & DEVELOPMENT FUND FOR HEALTH SERVICES, BNAI-ZION MEDICAL CENTER, Haifa (IL)

(72) Inventors: Mordechay Pinchas Freiman, Zichron Yaakov (IL); Eyal Hanania, Haifa (IL); Israe Cohen, Haifa (IL)

(73) Assignees: Technion Research & Development Foundation Limited, Haifa (IL); MEDICAL RESEARCH & DEVELOPMENT FUND FOR HEALTH SERVICES, BNAI-ZION MEDICAL CENTER, Haifa (IL)

(21) Appl. No.: 18/805,411

(22) Filed: Aug. 14, 2024

Related U.S. Application Data
(60) Provisional application No. 63/519,563, filed on Aug. 14, 2023.

(51) Int. Cl. G06T 7/00

(52) U.S. Cl. CPC G06T 7/0012; G06T 2207/10088; G06T 2207/20084

(57) ABSTRACT

A method for quantitative magnetic resonance imaging (MRI), the method includes (a) receiving a sequence of MRI images of an in vivo tissue, by an image registration deep neural network (DNN) module that was trained, by a training process, to impose one or more MRI signal related physical constraints on a content of the sequence of MRI images; and (b) extracting one or more quantitative map from the sequence of MRI images.

### CROSS REFERENCE

This application claims priority from U.S. provisional patent Ser. No. 63/519,563 filing date Aug. 14, 2023, which is incorporated herein by reference.

### BACKGROUND

The patent application refers to at least some of the following references, and the inclusion in of any reference in the following list is not indicative of a relevancy of the reference to the subject matter of this patent application:
[01] Cardiac t1 mapping dataset; https://cardiacmr.hms.harvard.edu/downloads-0.
[02] Balakrishnan, G., Zhao, A., Sabuncu, M. R., Guttag, J., Dalca, A. V.: Voxelmorph: a learning framework for deformable medical image registration. IEEE transactions on medical imaging 38(8), 1788-1800 (2019).
[03] Dalca, A. V., Balakrishnan, G., Guttag, J., Sabuncu, M. R.: Unsupervised learning of probabilistic diffeomorphic registration for images and surfaces. Medical image analysis 57, 226-236 (2019).
[04] El-Rewaidy, H., Nezafat, M., Jang, J., Nakamori, S., Fahmy, A. S., Nezafat, R.: Nonrigid active shape model-based registration framework for motion correction of cardiac t1 mapping. Magnetic resonance in medicine 80(2), 780-791 (2018).
[05] van de Giessen, M., Tao, Q., van der Geest, R. J., Lelieveldt, B. P.: Model-based alignment of look-locker MRI sequences for calibrated myocardical scar tissue quantification. In: 2013 IEEE 10th International Symposium on Biomedical Imaging. pp. 1038-1041. IEEE (2013).
[06] Gonzales, R. A., Zhang, Q., Papiez, B. W., Werys, K., Lukaschuk, E., Popescu, I. A., Burrage, M. K., Shanmuganathan, M., Ferreira, V. M., Piechnik, S. K.: Moconet: robust motion correction of cardiovascular magnetic resonance t1 mapping using convolutional neural networks. Frontiers in Cardiovascular Medicine p. 1689 (2021).
[07] Guo, R., El-Rewaidy, H., Assana, S., Cai, X., Amyar, A., Chow, K., Bi, X., Yankama, T., Cirillo, J., Pierce, P., et al.: Accelerated cardiac t1 mapping in four heartbeats with inline myomapnet: a deep learning-based t1 estimation approach. Journal of Cardiovascular Magnetic Resonance 24(1), 1-15 (2022).
[08] Hoffmann, M., Billot, B., Greve, D. N., Iglesias, J. E., Fischl, B., Dalca, A. V.: Synthmorph: learning contrast-invariant registration without acquired images. IEEE transactions on medical imaging 41(3), 543-558 (2021).
[09] Iglesias, M. A., Camara, O., Sitges, M., Delso, G.: Spatially constrained deep learning approach for myocardial t1 mapping. In: Functional Imaging and Modeling of the Heart: 11th International Conference, FIMH 2021, Stanford, CA, USA, Jun. 21-25, 2021, Proceedings. pp. 148-158. Springer (2021).
[10] Korngut, N., Rotman, E., Afacan, O., Kurugol, S., Zaffrani-Reznikov, Y., Nemirovsky-Rotman, S., Warfield, S., Freiman, M.: Super-ivim-dc: Intra-voxel incoherent motion based fetal lung maturity assessment from limited dwi data using supervised learning coupled with data-consistency. In: Medical Image Computing and Computer Assisted Intervention-MICCAI 2022: 25th International Conference, Singapore, Sep. 18-22, 2022, Proceedings, Part II. pp. 743-752. Springer (2022).
[11] Li, Y., Wang, Y., Qi, H., Hu, Z., Chen, Z., Yang, R., Qiao, H., Sun, J., Wang, T., Zhao, X., et al.: Deep learning-enhanced t1 mapping with spatial-temporal and physical constraint. Magnetic Resonance in Medicine 86(3), 1647-1661 (2021).
[12] Li, Y., Wu, C., Qi, H., Si, D., Ding, H., Chen, H.: Motion correction for native myocardial t1 mapping using self-supervised deep learning registration with contrast separation. NMR in Biomedicine 35(10), e4775 (2022).
[13] Roujol, S., Weingartner, S., Foppa, M., Chow, K., Kawaji, K., Ngo, L. H., Kellman, P., Manning, W. J., Thompson, R. B., Nezafat, R.: Accuracy, precision, and reproducibility of four t1 mapping sequences: a head-to-head comparison of molli, shmolli, sasha, and sapphire. Radiology 272(3), 683-689 (2014).
[14] Schelbert, E. B., Messroghli, D. R.: State of the art: clinical applications of cardiac t1 mapping. Radiology 278(3), 658-676 (2016).
[15] Taylor, A. J., Salerno, M., Dharmakumar, R., Jerosch-Herold, M.: T1 mapping: basic techniques and clinical applications. JACC: Cardiovascular Imaging 9(1), 67-81 (2016).
[16] Tilborghs, S., Dresselaers, T., Claus, P., Claessen, G., Bogaert, J., Maes, F., Suetens, P.: Robust motion correction for cardiac t1 and ecv mapping using a t1 relaxation model approach. Medical Image Analysis 52, 212-227 (2019).
[17] Weingartner, S., Roujol, S., Akcakaya, M., Basha, T. A., Nezafat, R.: Free-breathing multislice native myocardial t1 mapping using the slice-interleaved t1 (stone) sequence. Magnetic resonance in medicine 74(1), 115-124 (2015).
[18] Xue, H., Shah, S., Greiser, A., Guetter, C., Littmann, A., Jolly, M. P., Arai, A. E., Zuehlsdorff, S., Guehring, J., Kellman, P.: Motion correction for myocardial t1 mapping using image registration with synthetic image estimation. Magnetic resonance in medicine 67(6), 1644-1655 (2012).
[19] Yang, C., Zhao, Y., Huang, L., Xia, L., Tao, Q.: Disq: Disentangling quantitative mri mapping of the heart. In: Medical Image Computing and Computer Assisted Intervention—MICCAI 2022: 25th International Conference, Singapore, Sep. 18-22, 2022, Proceedings, Part VI. pp. 291-300. Springer (2022).
[20] Zhang, S., Le, T. T., Kabus, S., Su, B., Hausenloy, D. J., Cook, S. A., Chin, C. W., Tan, R. S.: Cardiac magnetic resonance t1 and extracellular volume mapping with motion correction and co-registration based on fast elastic image registration. Magnetic Resonance Materials in Physics, Biology and Medicine 31, 115-129 (2018).
[21] Dar Arava et al. “Deep-Learning based Motion Correction for Myocardial T 1 Mapping”. In: 2021 IEEE International Conference on Microwaves, Antennas, Communications and Electronic Systems (COMCAS). IEEE. 2021, pp. 55-59.

Quantitative T₁ mapping is a magnetic resonance imaging (MRI) technique that allows for the precise measurement of intrinsic longitudinal relaxation time in myocardial tissue [15]. “Native” T₁ mapping, acquired without administration of a paramagnetic contrast agent, has been found to be sensitive to the presence of myocardial edema, iron overload, as well as myocardial infarcts and scarring [14]. It is increasingly recognized as an indispensable tool for the assessment of diffuse myocardial diseases such as diffuse myocardial inflammation, fibrosis, hypertrophy, and infiltration [15].

The derivation of accurate T₁ maps necessitates a sequential acquisition of registered images, where each pixel characterizes the same tissue at different timepoints. However, the inherent motion of the heart, respiration, and spontaneous patient movements can introduce substantial distortions in the T₁ maps, ultimately impeding their reliability and clinical utility, and potentially leading to an erroneous diagnosis. [16]. Echo-triggering is a well-established approach to mitigate the effects of cardiac motion. Conversely, breath-hold sequences such as the Modified Look-Locker Inversion recovery (MOLLI) sequence and its variants [13] are commonly employed to suppress motion artifacts associated with respiration. However, the requirement for subjects to hold their breath places practical constraints on the number of images that can be acquired [13], as well as on the viability of the technique for certain patient populations who cannot tolerate breath-holding. Further, inadequate echo-triggering due to cardiac arrhythmia may lead to unreliable T₁ maps, compromising the diagnosis.

Alignment of the images obtained at different time-points via image registration can serve as a mitigation for residual motion and enable cardiac T₁ mapping with free-breathing sequences such as the slice-interleaved T₁ (STONE) sequence [17]. The intrinsic complexity of the image data, including contrast inversion, partial volume effects, and signal nulling for images acquired near the zero crossing of the T₁ relaxation curve, present a daunting task in achieving registration for these images. Zhang et al. [20] proposed to perform motion correction in T₁ mapping by maximizing the similarity of normalized gradient fields in order to address the intensity differences across different time points. El-Rewaidy et al. [4] employed a segmentation-based approach in which the residual motion was computed by matching manually annotated contours of the myocardium to the different images. Xue et al. [18] and more recently, Tilborghs et al. [16] proposed an iterative approach in which the signal decay model parameters are estimated and synthetic images are generated. Then, image registration used the predicted images to register the acquired data. Van De Giessen et al. [5] used directly the error on the exponential curve fitting as the registration metric to spatially align images obtained from a Look-Locker sequence.

Recently, deep-learning methods for image registration were employed as a pre processing step for motion correction in T₁ mapping [6, 12, 19]. Nevertheless, these methods do not account directly for the signal decay model, therefore they may produce physically-unlikely deformations. On the other hand, physically-informed deep-neural-networks (DNN) were proposed for various qMRI applications, including T₁ mapping [10, 11, 7, 9]. Yet, such methods do not account for motion between the acquisitions.

FIG. 1 is a schematic description of T₁ mapping for a single voxel. (a) T₁-weighted myocardial images at 11 sequential time points. (b) Fitting an inversion recovery curve of the longitudinal magnetization M_{z} over different time points t, and extracting the corresponding T₁ and M₀ parameters. (c) Displaying the computed T₁ map.

### SUMMARY

There are provided method, non-transitory computer readable media and systems as illustrated in the specification.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of T1 mapping;

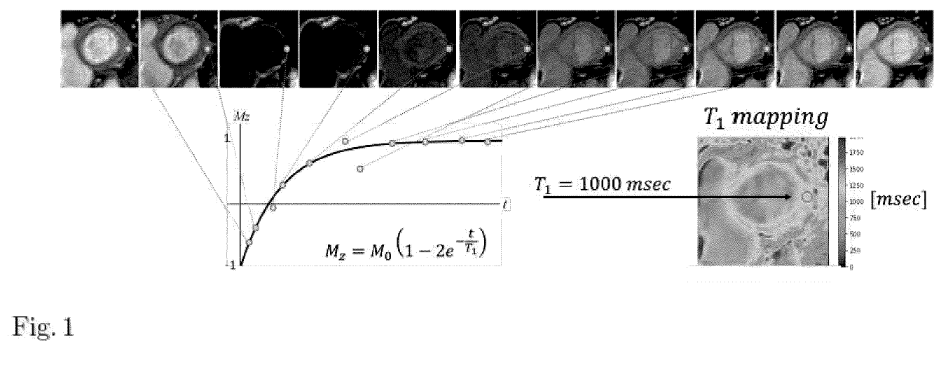

FIG. 2 illustrates an example of an overall architecture of PCMC-T1;

FIG. 3 illustrates examples of T1 mappings;

FIG. 4 illustrates an example of a table;

FIG. 5 illustrates an example of T1 mapping;

FIG. 6 illustrates an example of another overall architecture of PCMC-T1;

FIG. 7 illustrates examples of T1 mappings;

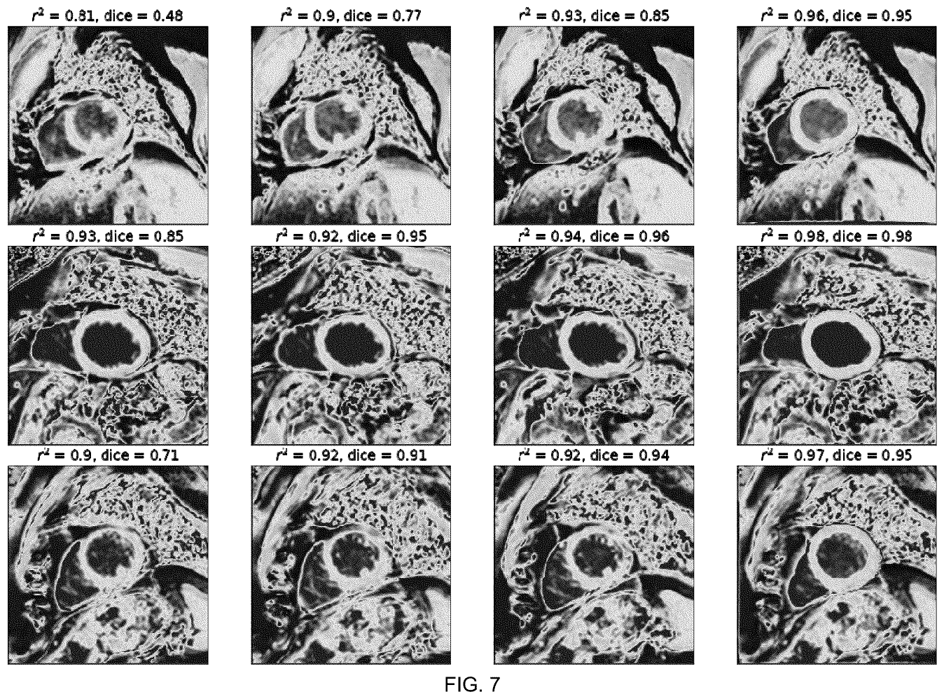

FIG. 8 illustrates an example of a table;

FIG. 9 illustrates an example of a method; and

FIG. 10 illustrates an example of a system.

### DETAILED DESCRIPTION OF THE DRAWINGS

There is provided PCMC-T1, a physically-constrained deep-learning model for simultaneous motion correction and T₁ mapping from free-breathing acquisitions. The suggested network architecture combined an image registration module and an exponential T₁ signal decay model fitting module. The incorporation of the signal decay model into the network architecture encourages physically-plausible deformations along the longitudinal relaxation axis.

The suggested PCMC-T1 model has the potential to expand the utilization of quantitative cardiac T₁ mapping to patient populations who cannot tolerate breath-holding by enabling automatic motion-robust accurate T₁ parameter estimation without additional manual annotation of the myocardium.

The inventors formulate the simultaneous motion correction and signal relaxation model estimation for qMRI T₁ mapping as—as illustrated in equation (1):

$${T}_{1} , , Φ = {argmin}_{{T}_{1} , {M}_{0} , Φ} {\sum }_{i = 0}^{N - 1} {‖ {M}_{0} \cdot ( 1 - 2 \cdot {e}^{\frac{- {t}_{i}}{{T}_{1}}} ) - {ϕ}_{i} ∘ {I}_{i} ‖}^{2} \qquad ( 1 )$$

where N is the number of acquired images, M₀, T₁ are the exponential signal relaxation model parameters, ϕᵢ is the i'th deformation field,

$${Φ}^{*} = {\{ ϕ \}}_{i = 0}^{N - 1} ,$$

Iᵢ is the i'th original image, and tᵢ is the i'th timestamp. However, direct optimization of this problem can be challenging and time-consuming [5].

### Model Architecture

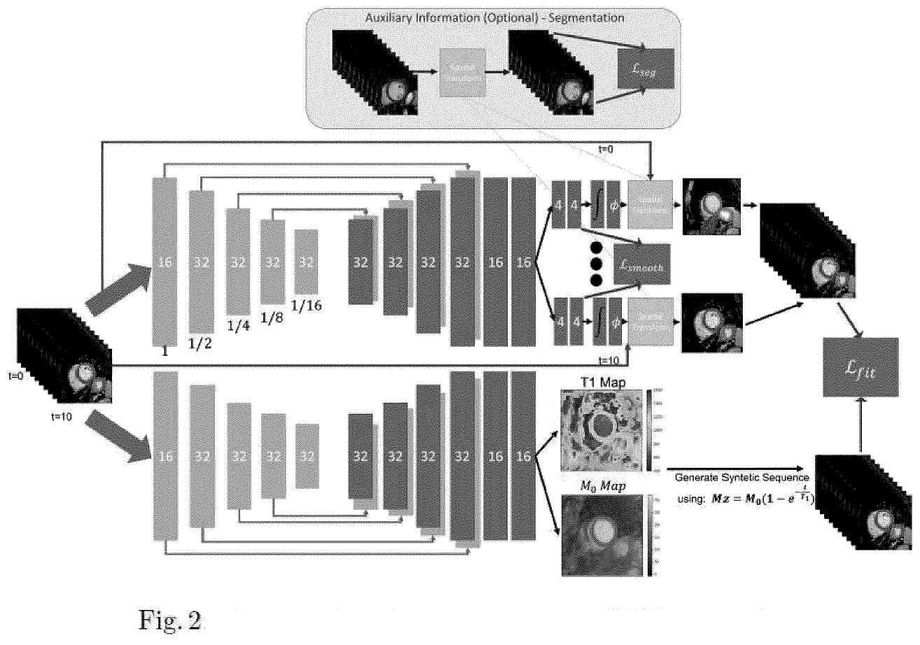

To overcome this challenge, the inventors propose PCMC-T1, a DNN architecture that simultaneously predicts the deformation fields and the exponential signal relaxation model parameters. FIG. 2 summarizes the overall architecture of the suggested model.

It includes two U-Net-like encoder-decoder modules that are operating in parallel. Skip connections are connecting between the encoder and the decoder of each model. The first encoder-decoder module is a multi-image deformable image registration module based on the voxelmorph architecture [2], while the second encoder-decoder module is the qMRI signal relaxation model parameters prediction module. The input of the DNN is a set of acquired images {Iᵢ|i=0 . . . N−1} stacked along the channel dimension. The first encoder-decoder is an extension of the pair-wise VoxelMorph model [2] for registration of multiple images.

The encoder is a U-Net-like encoder consisting of convolutional and down sampling layers with an increasing number of filters. The numbers 16, 32, 32, 32, 32, 32, 32, 32, 32, 32, 16 and 16 are the number of filters per layer. The numbers 1, ½, ¼, ⅛ and 1/16 illustrate the relationship between the sizes of the feature maps of the different layers. The number of filters per layers and/or the numbers related to the sizes of the feature maps are merely non-limiting examples of various values.

The layers (denoted 4, 4, ∫, ϕ) convert the velocity field outputted from the upper U-Net-like encoder-decoder to a deformation field.

The decoder output splits into multiple separated heads of convolutional layers and integration layers that produce a specific deformation field {ϕᵢ|i=0 . . . N−1} for each timestamp i. Skip connections are used to propagate the learned features into the deformation field prediction layers. A spatial warping layer is used to align the acquired images Iᵢ to the synthetics images generated from the signal relaxation model parameters predictions (Sᵢ): Rᵢ=Iᵢ°ϕᵢ. The specific details of the architecture are as in Balakrishnan et al [2] and the details of the integration layer are as in Dalca et al [3].

The second encoder-decoder has a similar architecture. It has two output layers representing the exponential signal relaxation model parameters: T₁ and M₀. The predicted parameters maps are then used, along with the input's timestamps {tᵢ|i=0 . . . N−1}, as input to a signal generation layer. This layer generates a set of synthetic, aligned, images {Sᵢ|i=0 . . . N−1} using the signal relaxation model—as illustrated in equation (2):

$${S}_{i} = {M}_{0} \cdot ( 1 - 2 \cdot {e}^{\frac{- {t}_{i}}{{T}_{1}}} )$$

### Loss Functions

The inventors encourage predictions of physically-plausible deformation fields by coupling three terms in the suggested loss function as—as illustrated in equation (3):

$${L}_{total} = {λ}_{1} \cdot {L}_{fit} + {λ}_{2} \cdot {L}_{smooth} + {λ}_{3} \cdot {L}_{seg}$$

The first term (L_{fit}) penalizes for differences between the model-predicted images generated by the model-prediction decoder and the acquired images warped according to the deformation fields predicted by the registration decoder. Specifically, the inventors use the mean-squared-error (MSE) between the registered images {Rᵢ|i=0 . . . N−1} and the synthetic images {Sᵢ|i=0 . . . N−1}—as illustrated in equation (4):

$${ℒ}_{fit} ( {T}_{1} , {M}_{0} , {t}_{i = 1}^{N - 1} , Φ ) = {\sum }_{i = 0}^{N - 1} {( {S}_{i} - {R}_{i} )}^{2}$$

where Sᵢ are the images generated with the signal model equation (Eq. 2), and the registered images are the output of the registration module. This term encourages deformation fields that are physically plausible by means of a signal relaxation that is consistent with the physical model of T₁ signal relaxation.

The second term (Lₛₘₒₒₜₕ) encourages the model to predict realistic, smooth deformation fields Φ by penalizing for a large l₂ norm of the gradients of the velocity fields [2] as illustrated in equation (5):

$${ℒ}_{smooth} ( Φ ) = {\sum }_{i = 0}^{N - 1} \frac{1}{Ω} {\sum }_{p ∈ Ω} {‖ ∇ {ϕ}_{i} ( p ) ‖}^{2}$$

where Ω is the domain of the velocity field and p are the voxel locations within the velocity field. In addition, the inventors encourage anatomically-consistent deformation fields by introducing a segmentation-based loss term (L_{seg}) as a third term in the overall loss function [2]. This term can be used in cases where the left ventricle (LV)'s epicardial and endocardial contours are available during training. Specifically, the segmentation loss function is defined as illustrated in equation (6):

$${ℒ}_{seg} ( r , {Seg}_{i = 0}^{N - 1} , {ϕ}_{i = 0}^{N - 1} ) = {\sum }_{i = 0 , i \neq r}^{N - 1} DiceLoss ( {Seg}_{r} , {Seg}_{i} {°ϕ}_{i} )$$

where Segᵢ, (i∈0, . . . , N−1) is the i'th binary segmentation mask of the myocardium, Segᵣ is the binary segmentation mask of the fixed image, and r is the index of the fixed image. This term can be omitted in cases where the segmentations of the myocardium are not available.

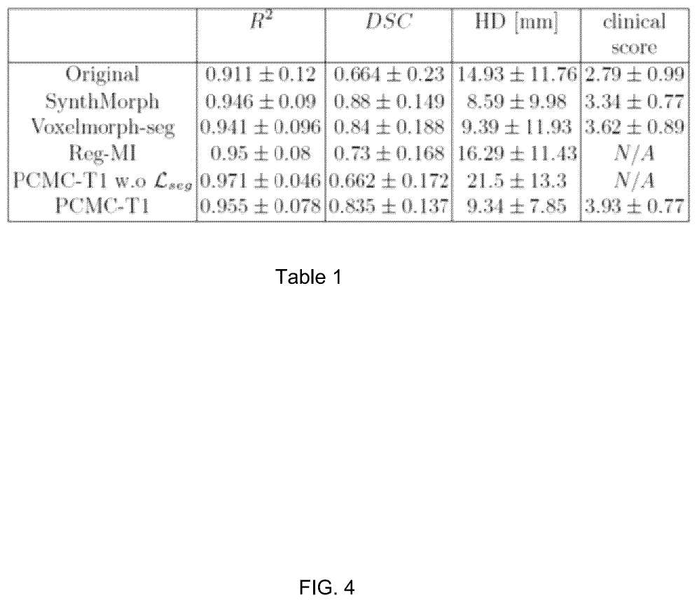

FIG. 4 illustrates table 1 which is a quantitative comparison between motion correction methods for myocardial T₁ mapping. All results are presented in mean±std.

### Implementation Details

The inventors implemented the suggested models in PyTorch. the inventors experimentally fixed the first time-point image, and predict deformation fields only for the rest of the time points, the inventors optimized the suggested hyperparameters using a grid search. The final setting for the loss function parameters were: λ₁=1, λ₂=500, λ₃=70000. the inventors used a batch size of 8, ADAM optimizer with a learning rate of 2·10⁻³. the inventors trained the model for 300 k iterations. the inventors used the publicly available TensorFlow implementations of the diffeomorphic VoxelMorph [3] and SynthMorph [8] as baseline methods for comparison, the inventors performed hyper-parameter optimization for baseline methods using a grid search. All experiments were run on an NVIDIA Tesla V100 GPU with 32G RAM.

### Experiments and Results

The inventors used the publicly available myocardial T₁ mapping dataset [4, 1]. The dataset includes 210 subjects, 134 males and 76 females aged 57±14 years, with known or suspected cardiovascular diseases. The images were acquired with a 1.5T MRI scanner (Philips Achieva) and a 32-channel cardiac coil using the ECG-triggered free-breathing imaging slice-interleaved T₁ mapping sequence (STONE) [17]. Acquisition parameters were: field of view (FOV)=360×351 [mm²], and voxel size of 2.1×2.1×8 [mm³]. For each patient, 5 slices were acquired from base to apex in the short axis view at 11 time points. Additionally, manual expert segmentation of the myocardium were provided as part of the dataset. the inventors cropped the images to a size of 160×160 pixels for each time point, the inventors normalized the images using a min-max normalization.

### Evaluation Methodology

Quantitative evaluation: the inventors used a 5-fold experimental setup. For each fold, the inventors divided the 210 subjects into 80% as a training set and 20% as a test set. the inventors conducted an ablation study to determine the added value of the different components in the suggested model. Specifically, the inventors compared the suggested method using a few variations, including a multi-image registration model with a mutual-information-based loss function (REG-MI), and the suggested method (PCMC-T1) without the segmentation loss term. the inventors used two state-of-the-art deep-learning algorithms for medical image registration including the pairwise probabilistic diffeomorphic VoxelMorph with a mutual-information-based loss [3], and pairwise SynthMorph [8], as well as with T₁ maps produced from the acquired images directly without any motion correction step. the inventors quantitatively evaluated the T₁ maps produced by the suggested PCMC-T1 model in comparison to T₁ maps produced after applying deep-learning-based image registration as a pre-processing step. the inventors used the R² of the model fit to the observed data in the myocardium, the Dice score, and Hausdorff distance values of the myocardium segmentations as the evaluation metrics.

The inventors further assessed the clinical impact of the suggested method by conducting a semi-quantitative ranking of the T₁ maps for the presence of motion artifacts by an expert cardiac MRI radiologist (3 years of experience) who was blinded to the methods used to generate the maps. the inventors randomly selected 29 cases (5 slices per case) from the entire dataset with their associated T₁ maps computed at inference time (i.e when the cases were not part of the model training). The radiologist was asked to rank each slice with 1 in case of a good quality map without visible motion artifacts and with 0 otherwise. the inventors computed overall patient scores by summing the slice grades. The maximum grade per subject was 5 for cases in which no motion artifacts were present in all slices and 0 for cases in which motion artifacts were present in all slices, the inventors assessed the statistical significance with the repeated measures ANOVA test; p<0.05 was considered significant.

### Results

Quantitative evaluation: Table 1 summarizes the results. the suggested PCMC-T1 approach achieved the best result in terms of R² with the smallest variance. Although PCMC-T1 without the segmentation loss (L_{Seg}) achieved a higher R² result compared to PCMC-T1 with the segmentation loss, it degraded the Dice value, representing over-fitted predictions. On the other hand, the slightly higher Dice score and Hausdorff distance values obtained by baseline methods compared to PCMC-T1 suggest bias of these methods toward the registration of the segmentation maps rather than producing deformation fields that are consistent with the signal relaxation model. The balanced result of PCMC-T1 indicates an improvement in the physical plausibility of the deformations produced by PCMC-T1 by means of signal relaxation and anatomical consistency.

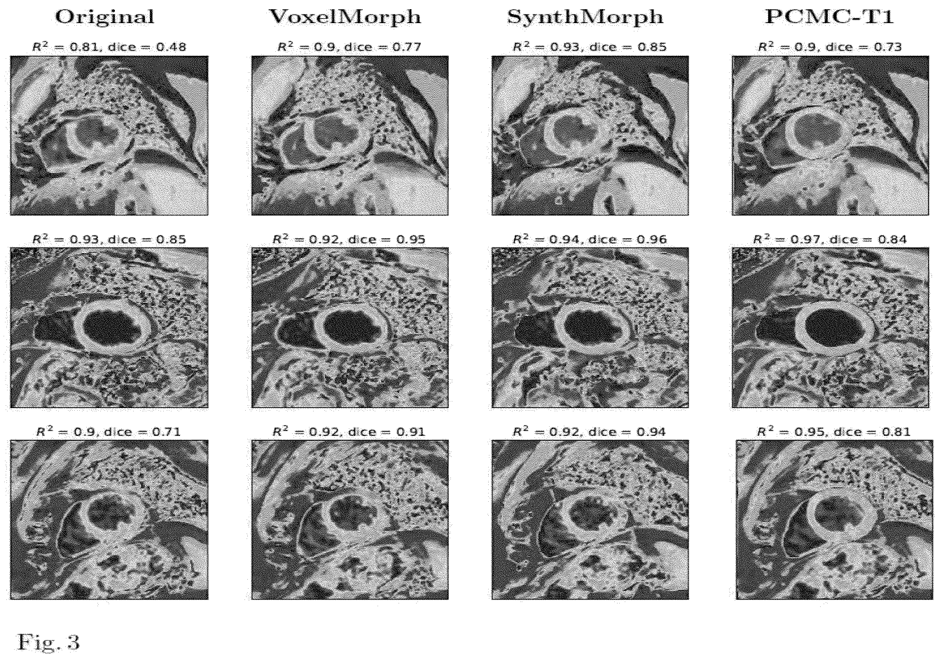

Clinical impact. FIG. 3 presents several representative cases. Although the Dice score of the baseline methods is higher compared to this of PCMC-T1, the quality of the maps produced by PCMC-T1 is better. The rightmost column of Table 1 summarizes the results of the clinical impact assessment of the suggested PCMC-T1 approach. the suggested PCMC-T1 received the highest quality score compared to the baseline methods. The difference in the radiologist grading was statistically significant (p<<10e⁻⁵). The improvement in the radiological evaluation suggests that PCMC-T1 provides a balanced result that is not overly biased toward the segmentations or toward the signal relaxation model.

FIG. 3 is representative T₁ maps computed with the different approaches. the suggested approach (PCMC-T1) demonstrates a clearer delineation between the blood and the muscle with a reduced partial volume effect, resulting in a more homogeneous mapping of the myocardium.

### Conclusions

The inventors presented PCMC-T1, a physically-constrained deep-learning model for motion correction in free-breathing T₁ mapping. The main contribution is the incorporation of the signal decay model into the network architecture to encourage physically-plausible deformations along the longitudinal relaxation axis. the inventors demonstrated a quantitative improvement by means of fit quality with comparable Dice score and Hausdorff distance. the inventors further assessed the clinical impact of the suggested method by conducting a qualitative evaluation of the T₁ maps produced by the suggested method in comparison to baseline methods by an expert cardiac radiologist, the suggested PCMC-T1 model holds the potential to broaden the application of quantitative cardiac T₁ mapping to patient populations who are unable to undergo breath-holding MRI acquisitions by enabling motion-robust accurate T₁ parameter estimation. Further, the proposed physically-constrained motion robust parameter estimation approach can be directly extended to additional qMRI applications.

### Self-Learning Implementation

Cardiac T1 mapping is often limited by the need for breath-holding to prevent motion artifacts, which restricts its use in patients who cannot hold their breath.

There is a need to create a self-supervised deep learning method for motion-corrected, free-breathing cardiac T1 mapping without requiring large datasets or worrying about data variability.

There is provided a new self-supervised model that combines a signal relaxation model with anatomical constraints and employs the voxel-morph framework for motion correction. the suggested model's performance was assessed using a publicly available myocardial T1 mapping dataset.

The suggested approach outperformed other state-of-the-art registration methods in terms of R2, DICE, and Hausdorff distance.

The suggested model offers the possibility of extending cardiac T1 mapping to patients who cannot perform breath-hold MRI procedures by ensuring robust motion correction for accurate T1 mapping, all without the necessity for large training datasets or worries about data anomalies.

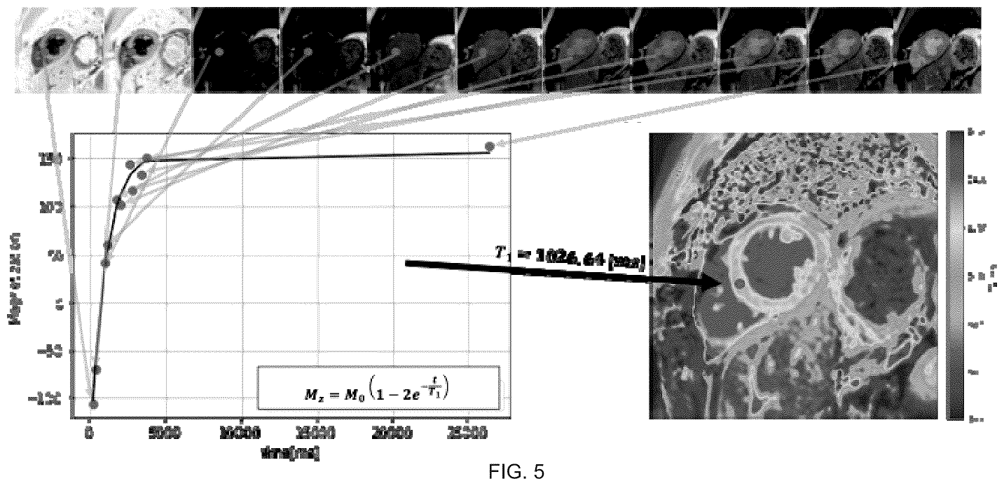

Quantitative T1 mapping via MRI (FIG. 5) is crucial for diagnosing diffuse heart diseases by measuring myocardial tissue's relaxation time [15]. Yet, its accuracy is often compromised by heart and respiratory motion, as well as patient movement, which can distort T1 maps and risk misdiagnosis [16]. While echo-triggering addresses heart motion and breath-hold techniques like MOLLI sequences [13] reduce respiratory effects, they're not suitable for patients who can't hold their breath or have irregular heartbeats, limiting the technique's use and potentially affecting the reliability of diagnoses.

Supervised deep-learning techniques have been introduced for aligning images to correct motion as a preliminary step in cardiac T1 mapping [6, 12, 19]. However, these techniques don't consider the signal decay inherent in the imaging process, which may result in unrealistic image distortions. Further, these methods require extensive training datasets and might be unstable to out-of-distribution data.

The inventors employed an open-access dataset for myocardial T1 mapping, comprising 210 individuals (134 males, 76 females) with an average age of 57±14 years, all with confirmed or potential cardiovascular issues. This data was collected on a 1.5T Philips Achieva MRI scanner with a 32-channel cardiac coil, using the ECG-triggered STONE sequence for free-breathing, slice-interleaved T1 mapping [17]. It provided 5 slices across 11 time points per patient, with expertly segmented myocardium.

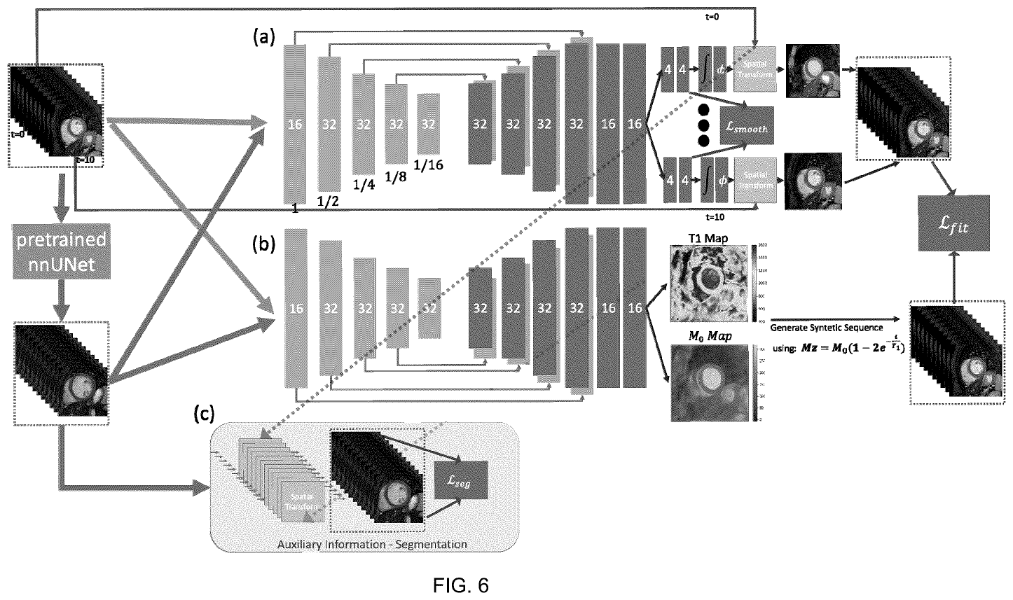

There is presented a self-supervised deep learning framework that simultaneously corrects for motion and computes T1 maps from free-breathing MRI acquisitions. This model (FIG. 6) melds a refined version of the Voxelmorph model for image registration [2], which now features multiple registration heads, with a module for fitting an exponential T1 signal decay model that utilizes an encoder-decoder structure to yield T1 and M0—the parameters representing exponential signal relaxation. Additionally, a pre-trained nnUNet designed for myocardial segmentation is integrated. This synergy between the signal decay fitting and myocardial segmentation ensures the model promotes deformations that are both physically and anatomically credible along the T1 relaxation trajectory.

While the two U-Net-like encoder-decoder modules of FIG. 2 was fed by a sequence of MRI images (that may have been manually tagged)—the two U-Net-like encoder-decoder modules are fed with an untagged sequence of MRI images and a segmented sequence of MRI images—the segmented sequence of MRI images was generated by a segmenting neural network—such as a pretrained U-Net-like neural network. The pretrained U-Net-like neural network may be trained to segment content other than MIR images. The pretrained U-Net-Like neural network may be trained using a self-supervised training process.

The inventors encourage the generation of deformations that are both physically and anatomically feasible by implementing a composite loss function. This function advances physical fidelity by applying Mean-squared Error loss to compare the deformed images with the anticipated T1 relaxation mode, and anatomical accuracy using Dice loss between the deformed segmentation. the inventors also ensure the smoothness of the deformation fields through the L2 norm on their gradients.

Experimental methodology: the inventors implemented a 5-fold cross-validation scheme with 210 participants to refine an nnUNet network dedicated to myocardial segmentation. Leveraging this network in a self-supervised fashion, the inventors input the T1-weighted (T1W) images and their associated nnUNet-derived segmentations into the suggested newly constructed network, which was uniquely tailored and fine-tuned for each participant's data. the suggested method was benchmarked against two cutting-edge deep learning medical image registration models: the pair-based probabilistic diffeomorphic VoxelMorph with a mutual-information loss function [2], and SynthMorph [9], along with REG-MI [21] and the PCMC-T1 disclosed in U.S. provisional patent Ser. No. 63/519,563 filing date Aug. 14, 2023, which are specially crafted for motion correction during T1 mapping. It should be noted that it is essential to highlight that SynthMorph is the sole exception among these models as being self-supervised; the others demand extensive training for each protocol.

Additionally, the inventors contrasted the suggested results with T1 maps calculated directly from raw images without applying motion correction. The evaluation of the suggested approach incorporated the determination of the R² value reflecting the model's fit to actual myocardial data, the Dice coefficient, and the Hausdorff distance measures for myocardium segmentation accuracy.

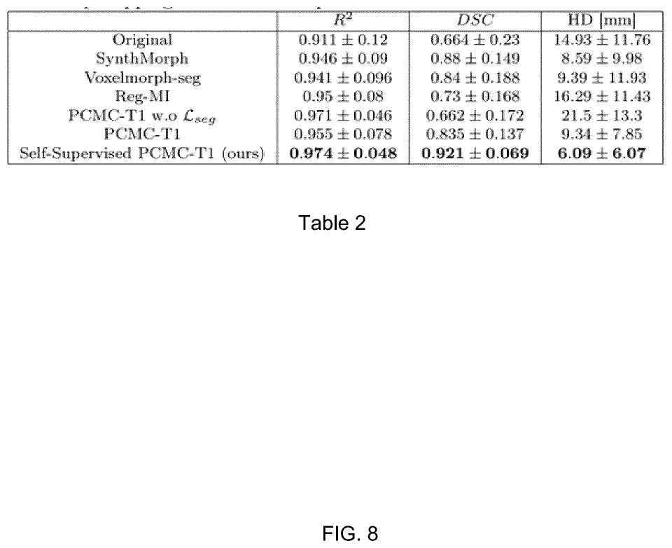

Results—FIG. 8 illustrates Table 2 that provides a summary of the suggested findings. the suggested Self-Supervised PCMC-T1 method demonstrated the highest performance in terms of R², DICE, and Hausdorff distance. These results suggest that the suggested approach enhances the physical plausibility of deformations through signal relaxation and anatomical consistency. the suggested results are particularly noteworthy considering that the inventors made comparisons with methods requiring a full training process and the use of manually annotated segmentations.

Conclusion: the inventors introduce a pioneering Self-Supervised method that fuses physical and anatomical insights for correcting motion in T1 mapping. the suggested breakthrough is the application of Self-Supervised learning and a pre-existing nnUNet framework, enriched with a signal decay model within the network's architecture. This allows for generating corrected T1 maps across various imaging protocols, eliminating the necessity for protocol-specific data collection and extensive training, the suggested findings show a significant improvement in fit quality, Dice score, and Hausdorff distance. The proposed model promises to widen the scope of quantitative cardiac T1 mapping to include patients who cannot perform breath-hold during MRI scans, ensuring precise T1 estimation despite motion.

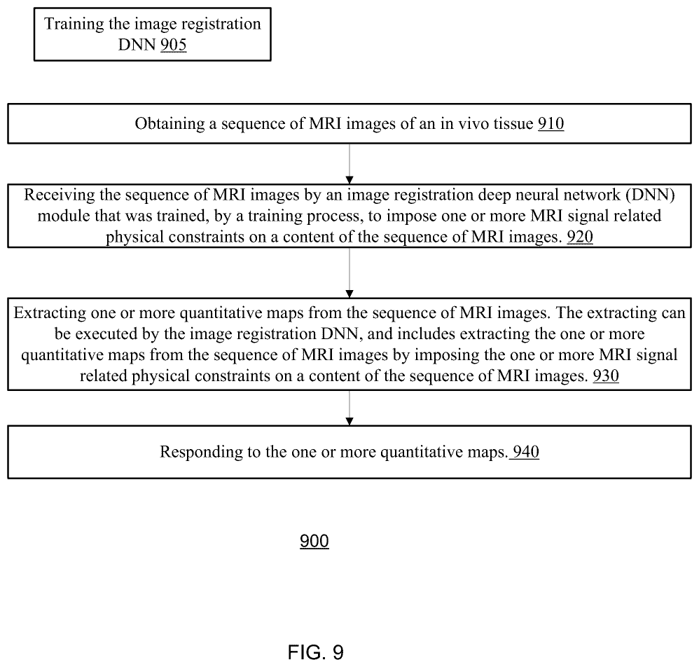

FIG. 9 illustrates an example of method 900 for quantitative magnetic resonance imaging (MRI).

According to an embodiment, method 900 starts by step 910 of obtaining a sequence of MRI images of an in vivo tissue. Step 910 may include generating the sequence of MRI images by an MRI system or receiving the sequence of MRI images—for example from the MRI system or from an MRI imager configured to generate the sequence of MRI images or from a storage unit or from a memory unit or from a communication link, and the like.

According to an embodiment, step 910 is followed by step 920 of receiving the sequence of MRI images by an image registration deep neural network (DNN) module that was trained, by a training process, to impose one or more MRI signal related physical constraints on a content of the sequence of MRI images.

According to an embodiment, step 920 is followed by step 930 of extracting one or more quantitative maps from the sequence of MRI images. According to an embodiment, step 920 includes extracting, by the image registration DNN, the one or more quantitative maps from the sequence of MRI images by imposing the one or more MRI signal related physical constraints on a content of the sequence of MRI images.

According to an embodiment, step 930 is followed by step 940 of responding to the one or more quantitative maps.

According to an embodiment, step 430 includes at least one of:
a. Storing the one or more quantitative maps in a memory unit and/or in a storage unit.
b. Transmitting the one or more quantitative maps over a communication link and/or communication channel and/or a bus, and the like.
c. Analyzing the more one or more quantitative maps to provide an indication on a health of a patient.
d. Analyzing the more one or more quantitative maps to provide a measurement of intrinsic longitudinal relaxation time in myocardial tissue.
e. Generating a health hazard alert when finding that the one or more quantitative maps are indicative of the health hazard.

According to an embodiment, the sequence of MRI images are obtained while the person is breathing. According to an embodiment, step 910 includes generating the sequence of MRI images are obtained while the person is breathing.

According to an embodiment, the one or more MRI signal related physical constrains include a quantitative MRI signal delay constraint.

According to an embodiment, the one or more MRI signal related physical constraints belong to a quantitative MRI signal relaxation model.

According to an embodiment, the image registration DNN module includes an encoder-decoder DNN which is a multi-image deformable image registration module.

According to an embodiment, method 900 includes step 9-5 (see dashed box denoted 905) of training the image registration DNN.

According to an embodiment, the training process includes: (a) feeding training MRI images to the image registration DNN module, and to a physical constraining DNN module; (b) generating, by the image registration DNN module, image registration DNN module output images; (c) generating, by the physical constraining DNN module, physical constraining DNN module output images; and (d) inducing the image registration DNN module to impose the one or more MRI related physical constraints by using a loss function that fits the image registration DNN module output images to the physical constraining DNN module output images.

According to an embodiment, the loss function is a mean square error loss function.

According to an embodiment, the training process is a self-training training process that include self-learning the image registration DNN

According to an embodiment, the quantitative MRI is a T1 mapping quantitative MRI.

According to an embodiment, the quantitative MRI differs from a T1 mapping quantitative MRI.

According to an embodiment, there is provided an MRI system, that includes a processing circuit that is configured to: implement a by an image registration deep neural network (DNN) module, the image registration DNN module is configured to receive a sequence of MRI images of an in vivo tissue, wherein the image registration DNN was trained, by a training process, to impose one or more MRI signal related physical constraints on a content of the sequence of MRI images; and extract one or more quantitative map from the sequence of MRI images.

According to an embodiment, the system includes an MRI imager that is configured to generate the sequence of MRI images.

According to an embodiment, there is provided a processing circuit, that is configured to implement an image registration deep neural network (DNN) module, the image registration DNN module is configured to receive a sequence of MRI images of an in vivo tissue, wherein the image registration DNN was trained, by a training process, to impose one or more MRI signal related physical constraints on a content of the sequence of MRI images; and extract one or more quantitative map from the sequence of MRI images.

According to an embodiment the processing circuit is a dedicated neural network processor.

According to an embodiment the processing circuit is a a graphic processing unit or a general purpose computer.

According to an embodiment the processing circuit includes at least a portion of at least one integrated circuit.

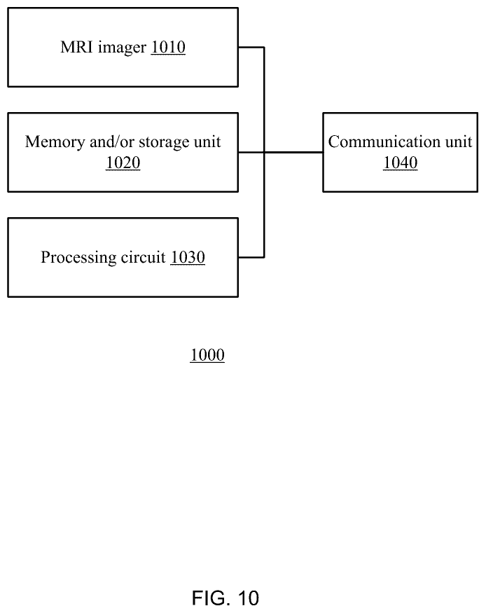

FIG. 10 illustrates an example of system 1000 that includes MRI imager 1010 configured to generate a sequence of MRI images, memory and/or storage unit 1020 configured to store the sequence of MRI images, processing circuit 1030 configured to extract one or more quantitative map from the sequence of MRI images by applying method 900, and communication unit 1040 configured to communicate the one or more quantitative maps.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for quantitative magnetic resonance imaging (MRI), the method comprises:
receiving a sequence of MRI images of an in vivo tissue, by an image registration deep neural network (DNN) module that was trained, by a training process, to impose one or more MRI signal related physical constraints on a content of the sequence of MRI images; and
extracting one or more quantitative map from the sequence of MRI images.

2. The method according to claim 1 wherein the sequence of MRI images are obtained while the person is breathing.

3. The method according to claim 1, wherein the one or more MRI signal related physical constrains comprises a quantitative MRI signal delay constraint.

4. The method according to claim 1 wherein the one or more MRI signal related physical constraints belong to a quantitative MRI signal relaxation model.

5. The method according to claim 1, wherein the image registration DNN module comprises an encoder-decoder DNN which is a multi-image deformable image registration module.

6. The method according to claim 1, comprising training the image registration DNN by a training process that comprises:
feeding training MRI images to the image registration DNN module, and to a physical constraining DNN module;
generating, by the image registration DNN module, image registration DNN module output images;
generating, by the physical constraining DNN module, physical constraining DNN module output images; and
inducing the image registration DNN module to impose the one or more MRI related physical constraints by using a loss function that fits the image registration DNN module output images to the physical constraining DNN module output images.

7. The method according to claim 6, wherein the loss function is a mean square error loss function.

8. The method according to claim 1, comprising self-training the image registration DNN

9. The method according to claim 1, wherein the quantitative MRI is a T1 mapping quantitative MRI.

10. The method according to claim 1, wherein the quantitative MRI differs from a T1 mapping quantitative MRI.

11. A non-transitory computer readable medium for quantitative magnetic resonance imaging (MRI), the non-transitory computer readable medium stores instructions for:
receiving a sequence of MRI images of an in vivo tissue, by an image registration deep neural network (DNN) module that was trained, by a training process, to impose one or more MRI signal related physical constraints on a content of the sequence of MRI images; and
extracting one or more quantitative map from the sequence of MRI images.

12. The non-transitory computer readable medium according to claim 11, wherein the sequence of MRI images are obtained while the person is breathing.

13. The non-transitory computer readable medium according to claim 11, wherein the one or more MRI signal related physical constrains comprises a quantitative MRI signal delay constraint.

14. The non-transitory computer readable medium according to claim 11, wherein the one or more MRI signal related physical constraints belong to a quantitative MRI signal relaxation model.

15. The non-transitory computer readable medium according to claim 11, wherein the image registration DNN module comprises an encoder-decoder DNN which is a multi-image deformable image registration module.

16. The non-transitory computer readable medium according to claim 11, that stores instructions for executing the training process by:
feeding training MRI images to the image registration DNN module, and to a physical constraining DNN module;
generating, by the image registration DNN module, image registration DNN module output images;
generating, by the physical constraining DNN module, physical constraining DNN module output images; and
inducing the image registration DNN module to impose the one or more MRI related physical constraints by using a loss function that fits the image registration DNN module output images to the physical constraining DNN module output images.

17. The non-transitory computer readable medium according to claim 16, wherein the loss function is a mean square error loss function.

18. The non-transitory computer readable medium according to claim 16, that stores instructions for self-training the image registration DNN.

19. The non-transitory computer readable medium according to claim 11, wherein the quantitative MRI is a T1 mapping quantitative MRI.

20. The non-transitory computer readable medium according to claim 11, wherein the quantitative MRI differs from a T1 mapping quantitative MRI.

21. A quantitative magnetic resonance imaging (MRI) system, the quantitative MRI system comprises:
a processing circuit that is configured to:
implement a by an image registration deep neural network (DNN) module, the image registration DNN module is configured to receive a sequence of MRI images of an in vivo tissue, wherein the image registration DNN was trained, by a training process, to impose one or more MRI signal related physical constraints on a content of the sequence of MRI images; and
extract one or more quantitative map from the sequence of MRI images.

22. The quantitative MRI system according to claim 21 comprising an imager that is configured to generate the sequence of MRI images.

23. A processing circuit, that is configured to implement an image registration deep neural network (DNN) module, the image registration DNN module is configured to receive a sequence of MRI images of an in vivo tissue, wherein the image registration DNN was trained, by a training process, to impose one or more MRI signal related physical constraints on a content of the sequence of MRI images; and extract one or more quantitative map from the sequence of MRI images.
